(19) United States
(12) Patent Application Publication
(10) Pub. No.: US 2026/0170537 A1
(43) Pub. Date: Jun. 18, 2026

(54) METHOD OF PROVIDING COMMERCIAL INFORMATION AND APPARATUS FOR CARRYING OUT THE SAME

(71) Applicants: HYUNDAI MOTOR COMPANY, SEOUL (KR); KIA CORPORATION, SEOUL (KR)

(72) Inventor: So Young Eom, Hwaseong-si (KR)

(73) Assignees: HYUNDAI MOTOR COMPANY, SEOUL (KR); KIA CORPORATION, SEOUL (KR)

(21) Appl. No.: 19/231,349

(22) Filed: Jun. 6, 2025

(30) Foreign Application Priority Data
Dec. 12, 2024 (KR) 10-2024-0184957

(51) Int. Cl. G06Q 30/0273; G06Q 30/0251

(52) U.S. Cl. CPC G06Q 30/0273; G06Q 30/0266

(57) ABSTRACT

The present disclosure introduces an information providing method and a server performing the same. The method includes dividing a driving route into a plurality of sections to which advertising costs are applied differently, and determining an advertising cost for providing the advertising information based on a section corresponding to the current location of the vehicle among the plurality of sections at the point in time of transmitting the advertising information.

### CROSS-REFERENCE TO RELATED APPLICATION(S)

The present application claims priority to Korean Patent Application No. 10-2024-0184957, filed Dec. 12, 2024, the entire contents of which are incorporated herein for all purposes by this reference.

### TECHNICAL FIELD

The present disclosure relates to an information providing method and a server performing the method. The method includes dividing a driving route into a plurality of sections to which advertising costs are applied differently, and determining an advertising cost for providing the advertising information based on a section corresponding to the current location of the vehicle among the plurality of sections at a point in time of transmitting the advertising information.

### BACKGROUND

Conventional navigation systems mounted on a vehicle show the current location and traveling direction of the vehicle through a display device using information received from Global Positioning System (GPS) satellites, and display the road, distance, and expected time that the vehicle should travel on the screen based on the current location when a destination is input.

The route display function provides more optimized route information using real-time traffic information, and even provides a multimedia contents playback function.

Recently, as the time of a vehicle occupant spending in the vehicle increases, a function that may increase users'convenience using a navigation system, e.g., advertising information for businesses around the driving route, may also be provided.

Meanwhile, a method that can maximize provision of the advertising information to the vehicle occupants and generation of profits by effectively transmitting the advertising information to vehicle occupants and distributing advertising costs differently may be useful.

The matters described as the background art are intended to enhance understanding of the background of the present disclosure, and not to acknowledge that this corresponds to the prior art already known to those skilled in the art.

### SUMMARY

The present disclosure has been proposed to solve such problems, and an object of the present disclosure is to provide an information providing method and a server performing the method, wherein the method includes dividing a driving route into a plurality of sections to which advertising costs are applied differently, and determining an advertising cost for providing the advertising information based on a section corresponding to the current location of the vehicle among the plurality of sections at a point in time (e.g., point time) of transmitting the advertising information.

The technical problems to be solved in the present disclosure are not limited to the technical problems mentioned above, and unmentioned other technical problems will be understood by those skilled in the art from the following description.

To accomplish the above object, an information providing method according to the present disclosure may include determining a driving route of a vehicle based on a starting point and a destination of the vehicle, by a server, dividing the driving route into a plurality of sections to which advertising costs are applied differently, transmitting advertising information to the vehicle based on a current location of the vehicle, and determining an advertising cost for providing the advertising information based on a section corresponding to the current location of the vehicle among the plurality of sections at a point in time of transmitting the advertising information.

In the information providing method according to an embodiment, the step of dividing the driving route into a plurality of sections may include the step of dividing the driving route into the plurality of sections based on a preset progress degree value.

In the information providing method according to an embodiment, the step of dividing the driving route into the plurality of sections may include the step of dividing the driving route into a first section, a second section, and a third section sequentially from the starting point to the destination.

In the information providing method according to an embodiment, the advertising cost may be set to be higher in order of the third section, the first section, and the second section.

In the information providing method according to an embodiment, the step of dividing the driving route into a plurality of sections may include the step of re-setting the plurality of sections, when a waypoint is determined, based on the waypoint.

In the information providing method according to an embodiment, the step of re-setting the plurality of sections may include the step of dividing the driving route into separate zones based on the waypoint, and dividing each zone into a plurality of sections.

In the information providing method according to an embodiment, the waypoints may include locations added by a vehicle occupant or points where the vehicle stops for a preset period of time before arriving at the destination.

In the information providing method according to an embodiment, the step of transmitting the advertising information to the vehicle may include the step of transmitting advertising information related to businesses located within a preset radius from the current location of the vehicle.

In the information providing method according to an embodiment, the step of determining an advertising cost may include the step of determining the advertising cost by reflecting responses of the vehicle occupants to the advertising information.

In the information providing method according to an embodiment, the step of determining an advertising cost may include the step of determining a cumulative advertising cost for each business in units of a preset period of time.

To accomplish the above object, a server according to the present disclosure may include a communication unit for receiving a starting point and a destination from a vehicle and transmitting advertising information, and a control unit for determining a driving route based on the starting point and the destination received from the vehicle, dividing the driving route into a plurality of sections to which advertising costs are applied differently, transmitting the advertising information to the vehicle based on a current location of the vehicle, and determining an advertising cost for providing the advertising information based on a section corresponding to the current location of the vehicle among the plurality of sections at a point in time of transmitting the advertising information.

In the server according to an embodiment, the control unit divides the driving route into the plurality of sections based on a preset reference of a distance ratio, wherein the preset reference of a distance ratio may include a plurality of progress degree values that distinguish sections adjacent to each other among the plurality of sections.

In the server according to an embodiment, the control unit may divide the driving route into a first section, a second section, and a third section sequentially from the starting point to the destination.

In the server according to an embodiment, the advertising cost may be set to be higher in order of the third section, the first section, and the second section.

In the server according to an embodiment, the control unit may re-set the plurality of sections, when a waypoint is determined, based on the waypoint.

In the server according to an embodiment, the control unit may divide the driving route into separate zones based on the waypoint, and divide each zone into a plurality of sections.

In the server according to an embodiment, the waypoints may include locations added by a driver or points where the vehicle stops for a preset period of time before arriving at the destination.

In the server according to an embodiment, the control unit may transmit advertising information related to businesses located within a preset radius from the current location of the vehicle.

In the server according to an embodiment, the control unit may determine the advertising cost by reflecting responses of vehicle occupants to the advertising information.

In the server according to an embodiment, the control unit may determine a cumulative advertising cost for each business in units of a preset period of time.

According to the information providing method of the present disclosure and the server performing the same, the profits according to exposure of advertising information can be maximized by determining an advertising cost for providing the advertising information based on a section corresponding to the current location of the vehicle among the plurality of sections at the point in time of transmitting the advertising information, and determining the advertising cost differently for the exposed advertising information.

The effects that can be obtained from the present disclosure are not limited to the effects mentioned above, and unmentioned other effects will be understood by those skilled in the art from the following description.

### BRIEF DESCRIPTION OF THE DRAWINGS

FIG. 1 is a view of a configuration of a vehicle and a server, and the operation of the vehicle and the server according to an embodiment of the present disclosure.

FIG. 2 and FIG. 3 are views of embodiments of dividing a driving route into a plurality of sections.

FIG. 4 is a flowchart illustrating the operation of a server according to an embodiment of the present disclosure.

FIG. 5 is a flowchart illustrating a step of dividing a driving route into a plurality of sections to which advertising costs are applied differently according to an embodiment of the present disclosure.

FIG. 6 is a flowchart illustrating the operation of a vehicle according to an embodiment of the present disclosure.

FIG. 7 is a view showing advertising information output through an output device of a vehicle according to an embodiment of the present disclosure.

### DETAILED DESCRIPTION

In describing the embodiments disclosed in this specification, when it is determined that description of related techniques may obscure the embodiments disclosed in this specification, the detailed description thereof may be omitted. In addition, the attached drawings are intended to make it easy to understand the embodiments disclosed in this specification, and the technical spirits disclosed in this specification are not limited by the attached drawings, and it should be understood that they include (e.g., all) modifications, equivalents, and substitutes included in the spirits and technical scope of the present disclosure. The following disclosure is not intended to limit the present disclosure to the described forms or specific fields, and it is considered that various alternative embodiments and modifications of the present disclosure are possible, regardless of whether they are (e.g., explicitly) described or implied in this specification. Those skilled in the art will recognize that the form and details of the contents of the present disclosure may be changed.

The present disclosure is described with reference to specific embodiments. However, as is understood by those skilled in the art, various embodiments disclosed in this specification may be modified in various other ways or implemented differently without departing from the spirit and scope of the present disclosure. Accordingly, the following description should be considered as illustrative and is intended to teach those skilled in the art how to make and use various embodiments. It will be understood that the forms of the disclosure shown and described in this specification may be taken as representative embodiments. Equivalent elements or materials, processes, or steps may be substituted with those exemplified and described in this specification. The expressions such as “including”, “comprising”, “incorporating”, “consisting of”, “have”, “is”, and the like used in describing the present disclosure should be construed in a non-exclusive manner, that is, the items, components, or elements not explicitly described are allowed to be displayed as well. In addition, reference to singular should be construed as including those related to plural.

In addition, various embodiments disclosed in this specification should be accepted an illustrative and descriptive meaning and should not be construed as limiting the contents of the present disclosure. All references to joining (e.g., attached, affixed, coupled, connected, and/or the like) are used to assist understanding of the present disclosure and do not limit the location, direction, or use of the configuration or the method disclosed in this specification. Accordingly, when references to joining exist, this should be interpreted in a broad sense. Moreover, in the references to joining, it is not determined that two or more elements are directly connected to each other. Additionally, (e.g., all) numeric terms, for example, “first”, “second”, “third”, “primary”, “secondary”, “main”, and any other generic or numeric terms, are to assist understanding of various components, forms, changes, or modifications of the present disclosure, and do not mean that they are limited to certain components, forms, changes, modifications, or the order or preference thereof. That is, although these expressions may be used to describe various components, the components are not limited by corresponding expressions. Corresponding expressions are used to distinguish one component from the other components.

Suffixes such as “module” and “unit” for the components used in the following description are given or interchangeably used considering the convenience of writing the specification, and do not have meanings or functions distinguished from each other by themselves.

When it is mentioned that a component is “connected” or “coupled” to another component, it should be understood that although the component may be directly connected or coupled to another component, there may be other components in between. On the other hand, when it is mentioned that a component is “directly connected” or “directly coupled” to another component, it should be understood that there are no other components in between.

In addition, the terms “unit” or “control unit” included in the names are merely terms widely used to name a control device (controller) that controls a specific function of a vehicle, and do not mean a generic function unit.

The controller may include a communication device that communicates with other controllers or sensors to control the functions in charge of, a memory that stores operating systems or logic commands and input/output information, and one or more processors that perform determination, calculation, decision, and the like needed for controlling the functions in charge of.

In a configuration among the configurations described in this specification, an arbitrary number of components or various components may be included in the disclosure described in this specification. The components may include any combination of feature units described in this specification and may be arranged as any configuration among the various configurations described in this specification. The concepts related to the structure and arrangement of the components of this disclosure, as well as their use and operation, may be applied to an arbitrary combination and an arbitrary number of embodiments, as well as the specific embodiments discussed in this specification. Embodiments that include those having various features of various arrangements are described below with reference to the drawings.

Hereinafter, various embodiments disclosed in this specification will be described in detail with reference to the attached drawings, and regardless of the drawing symbols, like reference numerals are given to like or similar components, and duplicate descriptions thereof will be omitted.

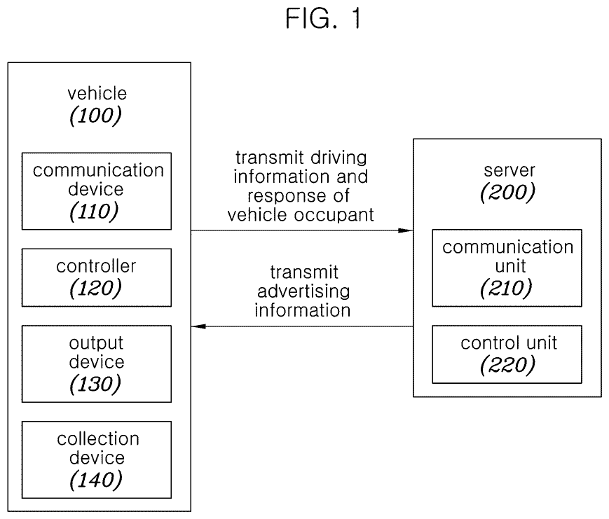

FIG. 1 is a view of a configuration and operation of a vehicle and a server according to an embodiment. The vehicle and the server of the present disclosure will be described with reference to the drawing.

Referring to FIG. 1, a vehicle according to an embodiment of the present disclosure may include a communication device 110, a controller 120, an output device 130, and a collection device 140. FIG. 1 shows components related to an embodiment of the present disclosure, and an actual vehicle may include fewer or more components than this.

Hereinafter, each component of the vehicle is described.

In an embodiment, the communication device 110 may transmit driving information of the vehicle 100 to the server 200 under the control of the controller 120, and may receive advertising information from the server 200 and transmit it to the controller 120.

The driving information may include information on at least one of the starting point, destination, current location, and/or waypoints of the vehicle 100.

The communication device 110 may include a wireless communication module such as a Wi-Fi, Bluetooth, or cellular network module for communication with the outside. However, this is an example and is not limited thereto.

The controller 120 may control transmitting the starting point, the destination, and the current location of the vehicle 100 to the server 200 through the communication device 110, and may control outputting the advertising information received from the server 200 to the vehicle occupants through the output device 130.

Additionally, the controller 120 may collect responses of the vehicle occupants to advertising information through the collection device 140.

In implementing the controller 120 according to an embodiment of the present disclosure, the controller 120 may be implemented as a function of an Audio/Video/Navigation (AVN) system provided in the vehicle 100. However, this is an example and is not necessarily limited thereto.

For example, the controller 120 may be implemented as a controller separated from the AVN controller, or may be implemented in a form in which the functions are distributed among two or more different controllers.

In an embodiment, the output device 130 may output the advertising information received from the server 200 under the control of the controller, wherein the output may include visual and auditory means, which can be perceived by the vehicle passengers.

The output device 130 may include a display device, a speaker, a Head Up Display (HUD), and the like. However, this is an example and is not limited thereto.

In an embodiment, the collection device 140 may collect responses of the vehicle occupants to the advertising information and transmit the responses to the controller 120.

The collection device 140 may include a camera, a motion recognition sensor, a touch screen, a pressure detection sensor, a microphone, and the like. However, this is an example and is not limited thereto.

Hereinafter, components of the server 200 will be described.

A communication unit 210 may receive driving information from the vehicle 100 under the control of a control unit 220 and transmit the driving information to the control unit 220. Further, advertising information may be transmitted to the vehicle 100.

The control unit 220 may determine a driving route and advertising information of the vehicle 100 based on driving information of the vehicle 100, control the advertising information to be transmitted to the vehicle 100 through the communication unit 210, and determine an advertising cost for providing the advertising information. In addition, the control unit 220 may receive responses of vehicle occupants to the advertising information through the communication unit 210, determine an advertising cost based on the responses, and determine a cumulative advertising cost for each business in units of a preset period of time. Meanwhile, the detailed operation process about this will be described below.

Hereinafter, the operation process of the vehicle and the server according to an embodiment of the present disclosure will be described in detail. It may be understood in the description below that the operations performed by the server 200, except for unique functions of the communication unit 210, are made based on the determination and decision of the control unit 220.

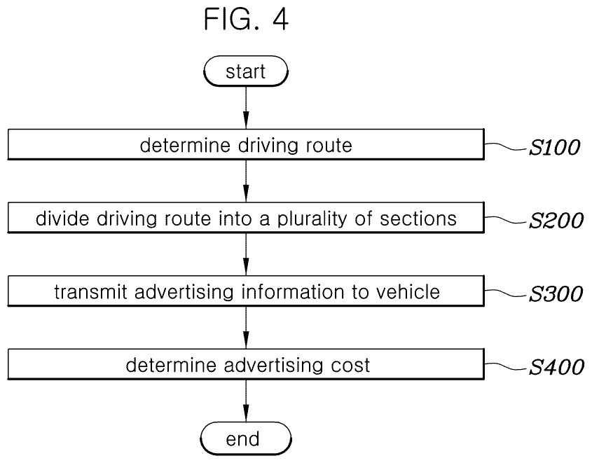

As illustrated in FIG. 4, in an embodiment, the server may determine a driving route of a vehicle based on driving information (S100).

The driving information may include the starting point, destination, current location, and waypoints of the vehicle.

The driving route may be a route connecting the starting point and the destination of the vehicle, the shortest path connecting the starting point and the destination of the vehicle, a route of the lowest cost, or a route that takes into account complex traffic situations. However, this is an example and is not limited thereto.

The driving information of the vehicle may be transmitted to the server through the communication device of the vehicle, and the server may receive the driving information through the communication unit.

In an embodiment, the server may divide a driving route into a plurality of sections to which advertising costs are applied differently (S200).

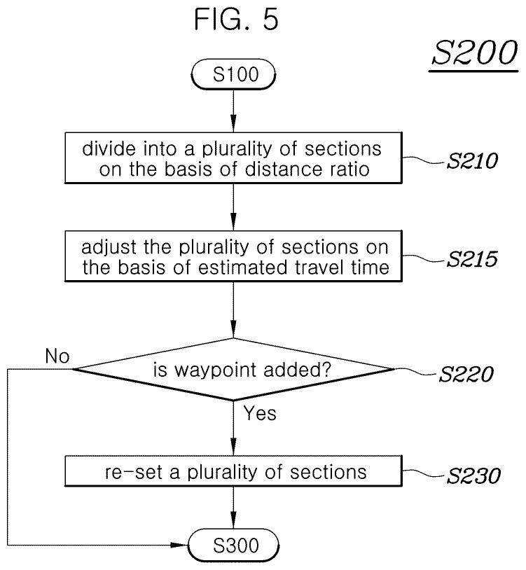

Step S200 is described in more detail with reference to FIG. 5.

As illustrated in FIG. 5, the server may divide a driving route into a plurality of sections based on a preset criterion of distance ratio (S210).

Here, the criterion of distance ratio may include a plurality of progress degree values that distinguish adjacent sections among the plurality of sections.

In addition, the advertising cost may be applied differently to each of the plurality of sections.

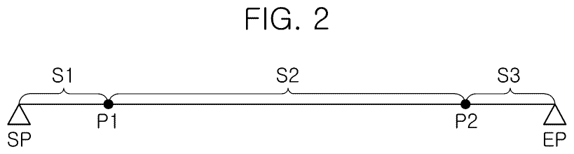

Referring to FIG. 2, the server may determine a driving route based on the starting point (SP) and the destination (e.g., end point) (EP), and the server may divide the driving route into three sections based on a first distance ratio, a second distance ratio, and a third distance ratio set in advance.

The driving route may be sequentially divided into a first section S1, a second section S2, and a third section S3 from the starting point SP to the destination EP.

A first progress degree value P1 may distinguish the first section S1 and the second section S2 adjacent to each other, and a second progress degree value P2 may distinguish the second section S2 and the third section S3 adjacent to each other. For example, when the first distance ratio is 10%, the second distance ratio is 80%, and the third distance ratio is 10%, the first progress degree value P1 may be 10% of the entire driving route, and the second progress degree value P2 may be 90% of the entire driving route, but this is an example and is not necessarily limited thereto.

The first section S1 may be defined as a section between the starting point SP and the first progress degree value P1, the second section S2 may be defined as a section between the first progress degree value P1 and the second progress degree value P2, and the third section S3 may be defined as a section between the second progress degree value P2 and the destination EP.

In addition, the advertising costs may be set to be higher in order of the third section S3, the first section S2, and the second section S3. However, this is an example and is not necessarily limited thereto. For example, the advertising costs may be set in order of high probability that the vehicle occupants respond to the advertising information, such as setting to be higher in order of the first section S1, the third section S3, and the second section S2, or the like.

Referring to FIG. 5 again, in an embodiment, the server may adjust the plurality of sections based on the estimated travel time in the plurality of sections (S215).

For example, the server may determine an estimated travel time in the entire driving route, determine an estimated travel time in each of the plurality of sections, and adjust the plurality of sections when the estimated travel time in each of the plurality of sections changes according to changes in the traffic situation, including traffic congestion or smooth (e.g., uninterrupted or less congested) traffic flow.

The server may divide the entire driving route into a first section, a second section, and a third section according to a preset distance ratio. The server may determine 50 minutes as the estimated travel time in the entire driving route, 5 minutes corresponding to 10% of the estimated travel time in the entire driving route for the first section, 40 minutes corresponding to 80% of the estimated travel time in the entire driving route for the second section, and 5 minutes corresponding to 10% of the estimated travel time in the entire driving route for the third section.

Thereafter, when the traffic is congested in the third section and the estimated travel time in the third section increases to be longer than the estimated travel time determined previously (for example, when the estimated travel time in the third section increases from 5 minutes to 10 minutes), the server may adjust the plurality of sections so that the estimated travel time in the third section becomes 10% of the total estimated travel time.

In addition, when traffic in the third section is smooth and the estimated travel time in the third section is reduced to be shorter than the estimated travel time determined previously (for example, when the estimated travel time in the third section is reduced from 5 minutes to 2.5 minutes), the server may adjust the plurality of sections so that the estimated travel time in the third section becomes 10% of the total estimated travel time. An example of change in the advertising cost is as shown below.

When the length of the entire driving route is 10 km and the total travel time is 50 minutes, the average travel time per km is 5 minutes. The first section is between 0 and 1 km and the estimated travel time is 5 minutes, the second section is between 1 and 9 km and the estimated travel time is 40 minutes, and the third section is between 9 and 10 km and the estimated travel time is 5 minutes.

When the traffic in the third section is smoother than the other sections and the estimated travel time in the third section is reduced although the third section is between 9 and 10 km, the third section may be adjusted to an 8.5 to 10 km section. In this case, before the adjustment, a business located at the 8.7 km point will be charged with the advertising cost for the second section, but after the adjustment, it may be charged with the advertising cost for the third section.

However, when the traffic is congested and the estimated travel time in the third section increases, the third section may be adjusted to a 9.5 to 10 km section. In this case, before the adjustment, a business located at the 9.2 km point will be charged with the advertising cost for the third section, but after the adjustment, it may be charged with the advertising cost for the second section.

Meanwhile, the example is for the convenience of explanation, and the step described above may be performed for the first section, as well as for the third section. According thereto, naturally, there may be an effect of adjusting the second section. In addition, the step described above is performed in real time to reflect the traffic situation, and may be performed before, after, or at the same time as the step of re-setting a plurality of sections according to addition of waypoints described below.

In an embodiment, the server may determine whether a waypoint of the vehicle is added (S220).

For example, the server may determine that a waypoint is added when the vehicle stops for a preset period of time before arriving at the destination. In addition, it may also determine that a waypoint is added when the waypoint is added by a vehicle occupant.

In other words, the waypoint may include locations added by a vehicle occupant or the waypoint may include a point (e.g., location) where the vehicle stops for a preset period of time before arriving at the destination.

The waypoint may be added in plural and may be added before or in the course driving of the vehicle.

In an embodiment, when a waypoint is added, the server may re-set a plurality of sections based on the waypoint (S230).

When a waypoint is determined, the server may divide the driving route into separate zones starting from the waypoint, and divide each zone into a plurality of sections.

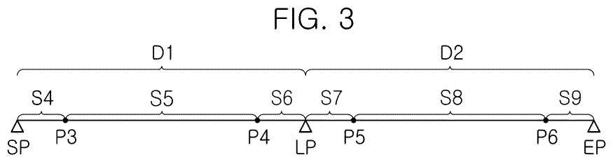

In the embodiment illustrated in FIG. 3, the server may determine a driving route based on a starting point SP, a destination EP, and a waypoint (e.g., location point) (LP), and may divide the driving route into a plurality of sections based on a preset distance ratio, and the distance ratio may include a plurality of progress degree values that distinguish sections adjacent to each other among the plurality of sections.

The server may divide the driving route starting from the waypoint LP into a first zone (e.g., distance 1) (D1) and a second zone (e.g., distance 2) (D2), and divide each zone into two sections.

The server may divide the first zone D1 into three sections based on fourth, fifth, and sixth distance ratios set in advance, and may divide the second zone D2 into three sections based on seventh, eighth, and ninth distance ratios set in advance.

The first zone D1 between the starting point SP and the waypoint LP may be sequentially divided into a fourth section S4, a fifth section S5, and a sixth section S6. The third progress degree value P3 may distinguish the fourth section S4 and the fifth section S5 adjacent to each other, and the fourth progress degree value P4 may distinguish the fifth section S5 and the sixth section S6 adjacent to each other.

For example, when the fourth distance ratio is 10%, the fifth distance ratio is 80%, and the sixth distance ratio is 10%, the third progress degree value P3 may be 10% of the first zone D1, and the fourth progress degree value P4 may be 90% of the first zone D1, but this is an example and is not necessarily limited thereto.

The second zone D2 between the waypoint LP and the destination EP may be sequentially divided into a seventh section S7, an eighth section S8, and a ninth section S9. The fifth progress degree value P5 may distinguish the seventh section S7 and the eighth section S8 adjacent to each other, and the sixth progress degree value P6 may distinguish the eighth section S8 and the ninth section S9 adjacent to each other.

For example, when the seventh distance ratio is 10%, the eighth distance ratio is 80%, and the ninth distance ratio is 10%, the fifth progress degree value P5 may be 10% of the second zone D2, and the sixth progress degree value P6 may be 90% of the second zone D2, but this is an example and is not necessarily limited thereto.

In addition, the advertising costs may be set to be higher in order of the sixth section S6, the fourth section S4, and the fifth section S5 in the case of the first zone D1, and may be set to be higher in order of the ninth section S9, the seventh section S7, and the eighth section S8 in the case of the second zone D2.

This is an example and is not necessarily limited thereto. For example, the advertising costs may be set in order of high probability that the vehicle occupants respond to the advertising information, such as setting to be higher in order of the fourth section S4, the sixth section S6, and the fifth section S5 in the case of the first zone D1, setting to be higher in order of the seventh section S7, the ninth section S9, and the eighth section S8 in the case of the second zone, and the like.

Returning to FIG. 4 again, the server may determine advertising information based on the current location of the vehicle, and transmit the advertising information to the vehicle (S300).

The server may transmit advertising information related to businesses located within a preset radius from the current location of the vehicle.

The advertising information may be advertising information related to a business previously registered in the server, and the advertising information may include the location and contact information of the business, events held by the business, and the like.

For example, the server 200 may transmit an advertisement so that the advertising information may be displayed on the output device 130 of the vehicle 100 in the form of a brand pin.

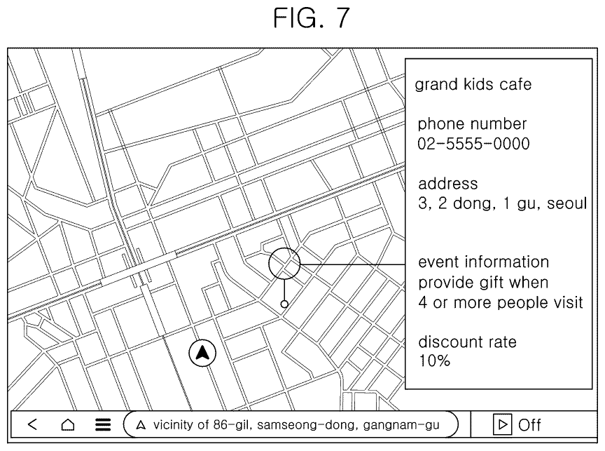

Referring to FIG. 7, the brand pin may be provided in the form of a pin displayed at a specific location on the map, and may include the location of a business, contact information including a phone number, an address, event information, and information on a discount rate.

In an embodiment, the server may determine an advertising cost for providing the advertising information based on a section corresponding to the current location of the vehicle among a plurality of sections at the point in time of transmitting the advertising information (S400).

As described above, the server may determine advertising costs to be different for a plurality of sections, and determine advertising costs for advertising information to be different according to a section corresponding to the current location of the vehicle at the point in time of transmitting the advertising information.

In the embodiment shown in FIG. 2, the advertising costs may be determined to be higher in order of when the vehicle is located in the third section S3, when the vehicle is located in the first section S1, and when the vehicle is located in the second section S2, at the point in time of transmitting the advertising information.

This is an example and is not necessarily limited thereto, and the advertising costs may be set in order of high probability that the vehicle occupants respond to the advertising information, such as when the vehicle is located in the first section S1, when the vehicle is located in the third section S3, and when the vehicle is located in the second section S2, at the point in time of transmitting the advertising information.

In the embodiment shown in FIG. 3, in determining the advertising costs for the advertising information, the server may (e.g., separately) determine an advertising cost for each of the zones divided by the waypoint LP.

In the first zone D1, the server may determine the advertisement costs to be higher in order of when the vehicle is located in the sixth section S6, when the vehicle is located in the fourth section S4, and when the vehicle is located in the fifth section S5, at the point in time of transmitting the advertising information.

This is an example and is not necessarily limited thereto, and the advertisement costs may be determined to be higher in order of when the vehicle is located in the fourth section S4, when the vehicle is located in the sixth section S6, and when the vehicle is located in the fifth section S5, at the point in time of transmitting the advertising information. That is, the advertising costs may be set in order of high probability that the vehicle occupants respond to the advertising information.

In the second zone D2, the server may determine the advertisement costs to be higher in order of when the vehicle is located in the ninth section S9, when the vehicle is located in the seventh section S7, and when the vehicle is located in the eighth section S8, at the point in time of transmitting the advertising information.

This is an example and is not necessarily limited thereto, and the advertisement costs may be determined to be higher in order of when the vehicle is located in the seventh section S7, when the vehicle is located in the ninth section S9, and when the vehicle is located in the eighth section S8, at the point in time of transmitting the advertising information. That is, the advertising costs may be set in order of high probability that the vehicle occupants respond to the advertising information.

The server may determine the advertising costs by reflecting the responses of vehicle occupants to the advertising information. Specifically, the server may receive the responses of vehicle occupants to the advertising information from the vehicle, and determine advertising costs for the advertising information based on the responses of vehicle occupants to the advertising information.

The server may determine a cumulative advertising cost for each business in units (e.g., of a preset period of time). Specifically, the server may count and store the number of times of exposing advertising information of each company to a plurality of vehicles in units (e.g., of a preset period of time), and determine a cumulative advertising cost for each business based on this.

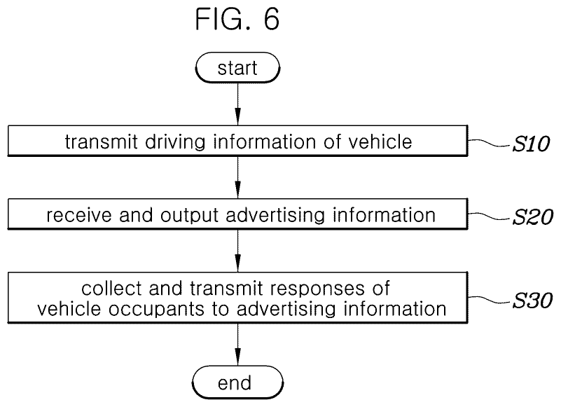

Next, the operation from the perspective of a vehicle according to an embodiment will be described with reference to FIG. 6.

Referring to FIG. 6, in an embodiment, a vehicle may transmit driving information to the server (S10).

The driving information may include the starting point, destination, and current location of the vehicle.

As described above, a waypoint may include the points where the vehicle stops for a preset period of time before arriving at the destination, or locations added by a vehicle occupant.

In an embodiment, the vehicle may receive advertising information from the server and output the advertising information (S20).

The communication device 110 of the vehicle may receive advertising information from the server 200 and transmit the advertising information to the controller 120 of the vehicle.

The controller 120 may control the output device 130 so that the advertising information is output to the vehicle occupants through the output device 130 of the vehicle.

The output device 130 may output the advertising information to vehicle occupants in a way including visual and auditory means, which can be perceived by the vehicle passengers.

For example, referring to FIG. 7, the output device 130 may output the advertising information in the form of a brand pin.

The brand pin may be provided in the form of a pin displayed at a specific location on the map, and may include the location of a business, contact information including a phone number, an address, event information, and information on a discount rate.

In an embodiment, the vehicle may collect responses of vehicle occupants to the advertising information and transmit the responses to the server (S30).

The collection device of the vehicle may collect and transmit responses of vehicle occupants to the advertising information to the controller, and the responses may be collected and transmitted in real time.

The controller may transmit the responses of vehicle occupants to the advertising information to the server through the communication device of the vehicle.

Although the present disclosure has been illustrated and described in relation to specific embodiments thereof, it may be apparent to those skilled in the art that the present disclosure may be diversely improved and changed without departing from the technical spirit of the present disclosure provided by the following claims.

What is claimed is:

1. An information providing method comprising:
determining, via a server, a driving route of a vehicle based on driving information including a starting point and a destination of the vehicle;
dividing the driving route into a plurality of sections;
determining advertising information based on a current location of the vehicle;
transmitting the advertising information to the vehicle; and
determining an advertising cost for providing the advertising information for a section of the plurality of sections, wherein the advertising cost corresponds to the current location of the vehicle at a point in time of transmitting the advertising information.

2. The information providing method of claim 1, wherein dividing the driving route into a plurality of sections includes dividing the driving route into the plurality of sections based on a preset distance ratio, wherein the distance ratio includes a plurality of progress degree values that differentiate sections adjacent to each other among the plurality of sections.

3. The information providing method of claim 2, wherein dividing the driving route into the plurality of sections includes dividing the driving route into a first section, a second section, and a third section sequentially from the starting point to the destination.

4. The information providing method of claim 3, wherein the advertising cost is higher in the third section than in the first section and the advertising cost is higher in the first section than in the second section.

5. The information providing method of claim 1, wherein dividing the driving route into a plurality of sections includes resetting the plurality of sections based on a waypoint, when a waypoint is added to the driving route.

6. The information providing method of claim 5, wherein re-setting the plurality of sections includes dividing the driving route into a plurality of zones based on the waypoint, and dividing each zone into a plurality of sections.

7. The information providing method of claim 1, wherein dividing the driving route into a plurality of sections includes adjusting the plurality of sections based on estimated travel time within each section of the plurality of sections.

8. The information providing method of claim 1, wherein transmitting the advertising information to the vehicle includes transmitting advertising information related to businesses located within a preset radius of the current location of the vehicle.

9. The information providing method of claim 1, wherein determining an advertising cost includes determining the advertising cost by reflecting responses of vehicle occupants to the advertising information.

10. The information providing method of claim 1, wherein determining an advertising cost includes determining a cumulative advertising cost for each business in units for a preset period of time.

11. A server comprising:
a communication unit for receiving driving information including a starting point and a destination of a vehicle from the vehicle and transmitting advertising information to the vehicle; and
a control unit for determining a driving route based on the driving information received from the vehicle, dividing the driving route into a plurality of sections, transmitting the advertising information to the vehicle based on a current location of the vehicle, and determining an advertising cost for providing the advertising information for a section of the plurality of sections, and outputting the advertising cost corresponding to the current location of the vehicle at a point in time of transmitting the advertising information.

12. The server of claim 11, wherein the control unit divides the driving route into the plurality of sections based on a preset distance ratio, wherein the distance ratio includes a plurality of progress degree values that differentiate adjacent sections among the plurality of sections.

13. The server of claim 11, wherein the control unit divides the driving route into a first section, a second section, and a third section sequentially from the starting point to the destination.

14. The server of claim 13, wherein the advertising cost is higher for the third section than for the first section, and the advertising cost for the first section is higher than for the second section.

15. The server of claim 11, wherein the control unit re-sets the plurality of sections based on a waypoint, when a waypoint is added to the driving route.

16. The server of claim 15, wherein the control unit divides the driving route into separate zones based on the waypoint, and divides each zone into a plurality of sections.

17. The server of claim 11, wherein the control unit re-sets the plurality of sections based on estimated travel time within each section of the plurality of sections.

18. The server of claim 11, wherein the control unit transmits advertising information related to businesses located within a preset radius from the current location of the vehicle.

19. The server of claim 11, wherein the control unit determines the advertising cost by considering responses of vehicle occupants to the advertising information.

20. The server of claim 11, wherein the control unit determines a cumulative advertising cost in units for each business for a preset period of time.
